(19) United States
(12) Patent Application Publication
(10) Pub. No.: US 2002/0019744 A1
(43) Pub. Date: Feb. 14, 2002

(54) Last will and testament service method, last will and testament service system, and storage medium storing programs to control same

(75) Inventor: Higashi Yamamoto, Tokyo (JP)

Correspondence Address: SUGHRUE, MION, ZINN,, MACPEAK & SEAS, PLLC, 2100 Pennsylvania Avenue, NW, Washington, DC, 20037-3213, US

(73) Assignee: NEC CORPORATION

(21) Appl. No.: 09/917,872

(22) Filed: Jul. 31, 2001

(30) Foreign Application Priority Data
Aug. 1, 2000 (JP) 2000-233557

(51) Int. Cl. G06F 17/60

(52) U.S. Cl. 705/1

(57) ABSTRACT

A last will and testament service method is provided which enables people to draw up their wills before their death without feelings of reluctance and the wills to be surely transferred after the death of a testator/testatrix. Will information and authentication information are produced by a testator terminal. The will information is registered on a last will and testament service terminal. Updating information and authentication information are transmitted by the testator terminal. The will information is updated by the last will and testament service terminal. A notice of death of the testator/testatrix is accepted by a public office terminal and is registered as dead person information and dead person information is transmitted. When the dead person information is received by the last will and testament service terminal and, after the death of the testator is confirmed, the will information is transmitted. The will information is received by an heir terminal.

### BACKGROUND OF THE INVENTION

1. Field of the Invention

The present invention relates to a last will and testament (will) service method and more particularly to the last will and testament service method and a last will and testament service system in which a testator/testatrix draws up a will before his/her death and registers his/her will with, for example, a service institution and, after his/her death, his/her will is transferred by the service institution to an heir of the testator/testatrix and to a storage medium storing programs to control the same.

The present application claims priority of Japanese Patent Application No.2000-233557 filed on Aug. 1, 2000, which is hereby incorporated by reference.

2. Description of the Related Art

A last will and testament system is a system by which a legal effect is given to a terminal wishes in the form of a last will and testament of a person that have been legally documented before the death of the person and his/her wishes are enforced after his/her death. For example, in Japan, a person is allowed to draw up a will whenever he/she becomes fifteen years old (Article 961 of the Japanese Civil Code) and last will and testament becomes effective after his/her death. Methods of the last will and testament are roughly classified into two: one being an ordinary method and another being a special method. The ordinary method includes the last will and testament by a holographic document (Article 968 of the Japanese Civil Code), last will and testament by a notary document (Article 969 of the Japanese Civil Code) and last will and testament by a secret document. The special method includes the last will and testament during emergencies (Articles 976 and 979 of the Japanese Civil Code) and last will and testament from remote places (Articles 977 and 978 of the Japanese Civil Code). In the last will and testament service method in which, for example, the will by the notary document is drawn up, a testator goes to an office of a notary public or asks the notary public to visit the testator and then requests the notary public to listen and write down contents of the will in the presence of two or more witnesses. The notary public reads contents of the thus written will to the testator and the witnesses for approval of fact and then the testator and the witnesses affix their signatures and/or seals to the will document. The will is held in custody of the office of the notary public as a notary document. Moreover, in the last will and testament service method in which the will by the secret document is drawn up, a signature and seal are affixed to the will written by the testator himself/herself (or the will may be drawn up by using a typewriter or a word processor) or written by an agent for the testator and, after being put under seal, the effect that the will exists in the sealed document is authenticated in the presence of two or more witnesses.

However, in the conventional last will and testament service method as described above, since the will is drawn up by the notary public, drawing-up and custody of the will cost the testator much and its use leans to limited people such as the aged and people living in a home for aged or a hospice who are aware that their death is near, therefore the last will and testament system is not yet used for many people. Moreover, people having a low probability of death are reluctant, in terms of concern, to draw up the will. Since an information transfer method to convey the will to those within immediate family of the testator is not yet established as a business, there is a problem that many people have no means of surely notifying about their wills to heirs being left after their deaths.

### SUMMARY OF THE INVENTION

In view of the above, it is an object of the present invention to provide a last will and testament service method and last will and testament service system in which a testator may draw up will before his death and register the will with, for example, a service institution and the service institution surely transfers the will to an heir of the testator after the death of the testator and a storage medium storing control programs of the same.

According to a first aspect of the present invention, there is provided a last will and testament service method in a last will and testament service system having a testator terminal, last will and testament service terminal, public office terminal, and communication line, including:

processing of producing will information and authentication information in which the testator terminal produces will information representing a will to an heir being left after the death of the testator and transmits it through the communication line to the last will and testament service terminal;

processing of registering the will information in which the last will and testament service terminal receives the will information and authentication information through the communication line and, after having authenticated the testator based on the authentication information, registers and takes custody of the will information and charges a predetermined fee to the testator;

upon said death of said testator, processing of transmitting dead person information in which the public office terminal accepts a notice of death and records it as dead person information and transmits the dead person information through the communication line to the last will and testament service terminal; and

processing of transmitting the will information in which the last will and testament service terminal receives the dead person information through the communication line and compares the dead person information with the authentication information and, if the dead person information matches with the testator, transmits the will information to the heir of the testator in an arbitrary manner.

According to a second aspect of the present invention, there is provided a last will and testament service method in a last will and testament service system having a testator terminal, last will and testament service terminal, public office terminal, and communication line, including:

processing of producing will information and authentication information in which the testator terminal produces will information representing a will to an heir being left after the death of a testator and transmits it through the communication line to the last will and testament service terminal;

processing of registering the will information in which the will service terminal receives the will information and authentication information through the communication line and, after having authenticated the testator based on the authentication information, registers and takes custody of the will information and charges a predetermined fee to the testator;

processing of transmitting updating information and authentication information in which the testator terminal transmits the updating information used to read, change, or add contents of the will information registered on the last will and testament service terminal, together with the authentication information, through the communication line, to the last will and testament service terminal;

processing of updating the will information in which the last will and testament service terminal receives the will information and authentication information through the communication line and, after having authenticated the testator based on the authentication line and, transmits, based on the updating information, the will information registered on the last will and testament service terminal, through the communication line, to the last will and testament terminal and changes or adds contents of the will information and charges a predetermined fee to the testator;

upon the death of the testator, processing of transmitting dead person information in which the public office terminal accepts a notice of death and records it as dead person information and transmits the dead person information through the communication line to the last will and testament service terminal; and

processing of transmitting the will information in which the last will and testament service terminal receives the dead person information through the communication line and compares the dead person information with the authentication information and, if the dead person information matches with the testator, transmits the will information to the heir of the testator in an arbitrary manner.

According to a third aspect of the present invention, there is provided a last will and testament service method in a last will and testament service system having a testator terminal, testator service terminal, public office terminal, and communication line, including:

processing of producing will information and authentication information in which the testator terminal produces the will information representing a will to an heir being left after the death of a testator and transmits it through the communication line to the last will and testament service terminal;

processing of registering the will information in which the last will and testament service terminal receives the will information and authentication information through the communication line and, after having authenticated the testator based on the authentication information, registers and takes custody of the will information and charges a predetermined fee to the testator;

upon the death of the testator, processing of transmitting dead person information in which the public office terminal accepts a notice of death and records it as dead person information and transmits the dead person information through the communication line to the last will and testament service terminal;

processing of transmitting the will information in which the testator service terminal receives the dead person information through the communication line and compares the dead person information with the authentication information and, if the dead person information matches with the testator, transmits the will information through the communication line to the testator terminal; and

processing of receiving the will information in which the testator terminal receives the will information transmitted from the last will and testament service terminal through the communication line.

According to a fourth aspect of the present invention, there is provided a last will and testament service method in a last will and testament service system having a testator terminal, last will and testament service terminal, public office terminal, and communication line, including:

processing of producing will information and authentication information in which the testator terminal produces will information representing a will to an heir being left after the death of a testator and transmits it through the communication line to the last will and testament service terminal;

processing of registering the will information in which the last will and testament service terminal receives the will information and authentication information through the communication line and, after having authenticated the testator based on the authentication information, registers and takes custody of the will information and charges a predetermined fee to the testator;

processing of transmitting updating information and the authentication information in which the testator terminal. transmits the updating information used to read, change, or add contents of the will information registered on the last will and testament service terminal, together with the authentication information, through the communication line, to the last will and testament service terminal;

processing of updating the will information in which the last will and testament service terminal receives the will information and authentication information through the communication line and, after having authenticated the testator based on the authentication information, transmits, based on the updating service terminal, the will information registered on the last will and testament service terminal, through the communication line, to the last will and testament terminal and changes or adds contents of the will information and charges a predetermined fee to the testator;

upon the death of the testator, processing of transmitting dead person information in which the public office terminal accepts a notice of death and records it as dead person information and transmits the dead person information through the communication line to the last will and testament service terminal;

processing of transmitting the will information in which the last will and testament service terminal receives the dead person information through the communication line and compares the dead person information with the authentication information and, if the dead person information matches with the testator, transmits the will information through the communication line to the testator terminal; and

processing of receiving the will information in which the testator terminal receives the will information transmitted from the last will and testament service terminal through the communication line.

In the foregoing, a preferable mode is one wherein the communication line is the Internet.

According to a fifth aspect of the present invention, there is provided a last will and testament service system including

a testator terminal;

a last will and testament service terminal;

a public office terminal;

a communication line; and

wherein the testator terminal, based on manipulation of a testator, is so configured as to produce will information representing a will to an heir being left after the death of a testator and authentication information used to authenticate the testator and to transmit it through the communication line to the last will and testament service terminal,

wherein the last will and testament service terminal, based on manipulation of an operator in charge of a last will and testament service, is so configured as to receive the will information and authentication information through the communication line and, after having authenticated the testator based on the authentication information, to register and take custody of the will information and to charge a predetermined fee to the testator; and upon the death of the testator, to receive dead person information through the communication line and to compare the dead person information with the authentication information and, if the dead person information matches with the testator, to transmit the will information to the heir of the testator in an arbitrary manner; and

wherein the public office terminal, based on manipulation of an operator in charge of receiving a notice of death, is so configured as to receive the notice of death and to record it as dead person information and to transmit the dead person information through the communication line to the last will and testament service terminal.

According to a sixth aspect of the present invention, there is provided a last will and testament service system including

a testator terminal;

a last will and testament service terminal;

a public office terminal;

a communication line; and

wherein the testator terminal, based on manipulation of a testator, is so configured as to produce will information representing a will to an heir being left after the death the testator and authentication information used to authenticate the testator and to transmit it through the communication line to the last will and testament service terminal and, at the same time, to transmit updating information used to read, change, and add contents of the will information, together with the authentication information, through the communication line, to the last will and testament service terminal,

wherein the last will and testament service terminal, based on manipulation of an operator in charge of a last will and testament service, is so configured as to receive the will information and authentication information through the communication line and, after having authenticated the testator based on the authentication information, to register and take custody of the will information and to charge a predetermined fee to the testator; and upon the death of the testator, to receive dead person information through the communication line and to compare the dead person information with the authentication information and, if the dead person information matches with the testator, to transmit the will information to the heir of the testator in an arbitrary manner and, at the same time, to receive the updating information and authentication information through the communication line and, after having authenticated the testator based on the authentication being registered through the communication line to the testator terminal and to change or add the will information and to charge a predetermined fee to the testator; and

wherein the public office terminal, based on manipulation of an operator in charge of receiving a notice of death, is so configured as to receive the notice of death and to record it as dead person information and to transmit the dead person information through the communication line to the last will and testament service terminal.

According to a seventh aspect of the present invention, there is provided a last will and testament service system including:

a testator terminal;

a last will and testament service terminal;

a public office terminal;

a communication line; and

wherein the testator terminal, based on manipulation of a testator, is so configured as to produce will information representing a will to an heir being left after the death of the testator and authentication information used to authenticate the testator and to transmit it through the communication line to the last will and testament service terminal,

wherein the last will and testament service terminal, based on manipulation of an operator in charge of a last will and testament service, is so configured as to receive the will information and authentication information through the communication line and, after having authenticated the testator based on the authentication information, to register and take custody of the will information and to charge a predetermined fee to the testator; and upon the death of the testator, to receive dead person information through the communication line and to compare the dead person information with the authentication information and, if the dead person information matches with the testator, to transmit the will information to the heir of the testator,

wherein the public office terminal, based on manipulation of an operator in charge of receiving a notice of death, is so configured as to receive the notice of death and to record it as dead person information and to transmit the dead person information through the communication line to the last will and testament service terminal; and

wherein the testator terminal, based on manipulation of the heir, is so configured as to receive the will information transmitted from the last will and testament service terminal through the communication line.

According to an eighth aspect of the present invention, there is provided a last will and testament service system including:

a testator terminal;

a last will and testament service terminal;

a public office terminal;

a communication line; and

wherein the testator terminal, based on manipulation of a testator, is so configured as to produce will information representing a will to an heir being left after the death of the testator and authentication information used to authenticate the testator and to transmit it through the communication line to the last will and testament service terminal and, at the same time, to transmit updating information used to read, change, and add contents of the will information, together with the authentication information, through the communication line, to the last will and testament service terminal,

wherein the last will and testament service terminal, based on manipulation of an operator in charge of a last will and testament service, is so configured as to receive the will information and authentication information through the communication line and, after having authenticated the testator based on the authentication information, to register and take custody of the will information and to charge a predetermined fee to the testator; and upon the death of the testator, to receive dead person information through the communication line and to compare the dead person information with the authentication information and, if the dead person information matches with the testator, to transmit the will information through the communication line to the testator terminal and, at the same time, to receive the updating information and the authentication information through the communication line and, after having authenticated the testator based on the authentication information, to transmit, based on the updating information, the will information being registered through the communication line to the testator terminal and to change or add the will information and to charge a predetermined fee to the testator; and

wherein the public office terminal, based on manipulation of an operator in charge of receiving a notice of death, is so configured as to receive the notice of death and to record it as dead person information and to transmit the dead person information through the communication line to the last will and testament service terminal; and

wherein the testator terminal, based on manipulation of the heir, is so configured as to receive the will information transmitted from the last will and testament service terminal through the communication line.

In the foregoing, a preferable mode is one wherein the communication line is the Internet.

According to a ninth aspect of the present invention, there is provided a storage medium storing control programs to have a computer implement a last will and testament service method stated above.

According to a tenth aspect of the present invention, there is provided a storage medium storing control programs to have a computer implement a last will and testament service method stated above.

With the above configuration, since the testator produces the will information by using the testator terminal and the will information is registered on the last will and testament service terminal through the communication line, the testator can draw up the will without a feeling of reluctance and with freedom to update. Moreover, when the testator has died, since registered will information is transferred from the last will and testament service terminal through the communication line to the heir terminal, the will is surely transferred to the heir without being left undiscovered. Therefore, the last will and testament service method of the present invention, in the coming aging society and in the society in which crimes producing random victims increase, can be used as preparations for unexpected death of not only people being aware of their death such as the aged but also youths or people of mature age and it is expected that the users of the last will and testament service who wish to live positively by being prepared for death can be increased.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing one example of configurations of a last will and testament service system to implement a last will and testament service method according to an embodiment of the present invention; and

FIG. 2 is a sequence diagram explaining the last will and testament service method according to the embodiment of the present invention.

### DETAILED DESCRIPTION OF THE PREFERRED EMBODIMENTS

Best modes of carrying out the present invention will be described in further detail using various embodiments with reference to the accompanying drawings.

### Embodiment

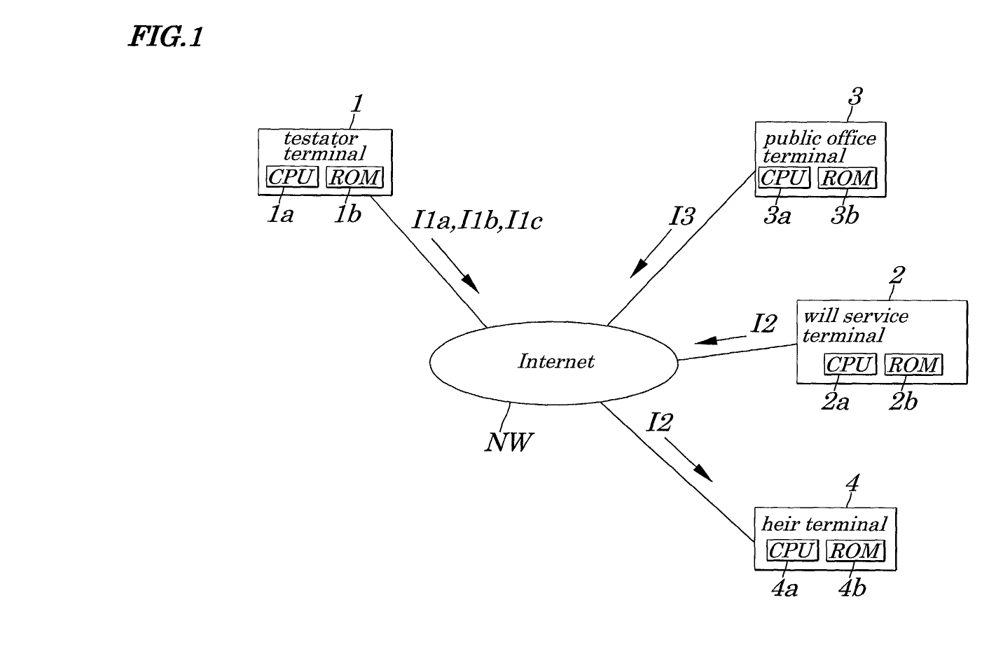

FIG. 1 is a schematic block diagram showing one example of configurations of a last will and testament service system to implement a last will and testament service method according to an embodiment of the present invention. The last will and testament service system of the embodiment, as shown in FIG. 1, includes a testator terminal 1, a last will and testament service terminal (hereinafter referred to as a will service terminal) 2, a public office terminal 3, a heir terminal 4 and communication line (for example, the Internet NW). The testator terminal 1 is an information processing device such as a personal computer installed, for example, at a home of a testator, which has a central processing unit (CPU) 1a used to control the entire testator terminal 1 and a storage medium (for example, ROM 1b (Read Only Memory)) storing control programs to operate the CPU 1a. The testator terminal 1, based on manipulation of the testator, produces will information I1a representing a last will and testament to a heir being left after the death of the testator and authentication information I1b used to authenticate the testator and transmits the produced information through the Internet NW to the will service terminal 2, together with updating information I1c used to read, change, or add contents of the will information I1a.

The will service terminal 2 is an information processing device such as a personal computer installed, for example, at a last will and testament service institution or a like, which has a CPU 2a used to control the entire will service terminal 2 and a ROM 2b storing control programs to operate the CPU 2a. The will service terminal 2, based on manipulation of an operator in charge of a last will and testament service, receives the will information I1a and the authentication information I1b through the Internet NW and, after having authenticated the testator based on the received authentication information I1b, registers the will information I1a therewith and takes custody of the will and, at the same time, charges a specified fee to the testator. Moreover, the will service terminal 2 receives dead person information I3 transmitted from the public office terminal 3 through the Internet NW and compares the dead person information I3 with the will information I1a and, if the dead person information I3 matches with the testator, transmits a will information I2 showing contents of the will information I1a to the heir terminal 4 through the Internet NW. The will service terminal 2 receives the updating information I1c and the authentication information I1b through the Internet NW and, after having authenticated the testator based on the authentication information I1b, transmits the will information I1a based on the updating information I1c through the Internet NW and, at the same time, changes or add contents of the will information I1a and charges a specified fee to the testator.

The public office terminal 3 is an information processing device such as a personal computer or a like installed, for example, at a death notice accepting section of a public office, which has a CPU 3a used to control the entire public office terminal 3 and a ROM 3b storing control programs to operate the CPU 3a. The public office terminal 3, based on manipulation of an operator at the death notice accepting section of the public office, accepts the notice of death and records it as the dead person information I3 and transmits the dead person information I3 to the will service terminal 2 through the Internet NW.

The heir terminal 4 is an information processing device such as a personal computer or a like, which has a CPU 4a used to control the entire heir terminal 4 and a ROM 4b storing control programs to operate the CPU 4a. The heir terminal 4, based on manipulation of the heir, receives the will information I2 through the Internet NW.

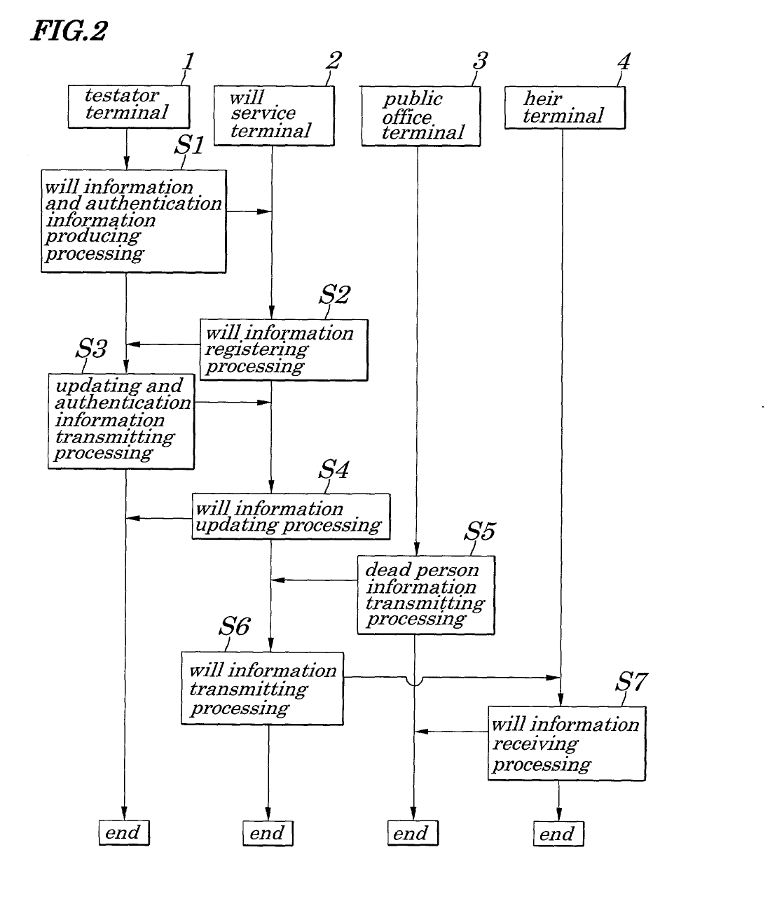

FIG. 2 is a sequence diagram explaining the last will and testament service method according to the embodiment of the present invention. Operations for the last will and testament service method will be explained by referring to FIG. 2.

Based on manipulation of the testator, the will information I1a and the authentication information I1b are produced by the testator terminal 1 and are transmitted to the will service terminal 2 through the Internet NW (Step S1, will information and authentication information producing processing). The will information I1a and the authentication information I1b are received by the will service terminal 2, based on the manipulation of the operator in charge of the will service terminal 2, through the Internet NW and, after the testator has been authenticated based on the authentication information I1b, the will information I1a is registered and is held until death of the testator and a specified fee is charged to the testator (Step S2, will information registering processing). The specified fee is paid from a bank account of the testator. The authentication of the testator is implemented, by exchanging, in advance, a digital certificate used to authenticate the testator between the testator terminal 1 and the will service terminal 2, based on an algorithm of, for example, an SSL (Secure Sockets layer).

The updating information I1c used to read, change, or add contents of the will information I1a registered on the will service terminal 2 is transmitted, based on manipulation of the testator, by the testator terminal 1 to the will service terminal 2 through the Internet NW, together with the authentication information I1b (Step S3, updating and authentication information transmitting processing). The updating information I1c and authentication information I1b are received by the will service terminal 2, based on the manipulation of the operator in charge of the last will and testament service, through the Internet NW and, after the testator has been authenticated, based on the authentication information I1b, the registered will information I1a, based on the updating information I1c, is transmitted to the testator terminal 1 through the Internet NW and, at the same time, contents of the will information I1a are changed and added and a fee is charged to the testator (Step S4, will information updating processing). Like procedure in Step S2, the fee is paid from the bank account of the testator.

On the other hand, upon the death of the testator, the notice of death is accepted by the public office terminal 3 and is recorded as the dead person information I3, based on manipulation of the operator in charge of accepting the notice of death and the dead person information I3 is then transmitted through the Internet NW to the will service terminal 2 (Step S5, dead person information transmitting processing). The dead person information I3 is received by the will service terminal 2 through the Internet NW based on the manipulation of the operator in charge of the last will and testament service and comparison between the dead person information I3 and the will information I1a is made. If the dead person information I3 matches with the testator, the death of the testator is authenticated and the will information I2 showing contents of the will information I1a is transmitted through the Internet NW to the heir terminal 4 (Step S6, will information transmitting processing). At this point, to transmit the will information I2, an electronic mail, for example, is used. The will information I2 transmitted from the will service terminal 2 is received by the heir terminal 4, based on manipulation of the heir, through the Internet NW (Step S7, will information receiving processing).

Thus, according to the embodiment, since the testator produces the will information I1a using the testator terminal 1 and the will information I1a is registered on the will service terminal 2 through the Internet NW, the testator can draw up a will without a feeling of reluctance. Moreover, since the will information I2 is transmitted from the will service terminal 2 through the Internet NW to the heir terminal 4, the will is surely transferred to the heir without being left undiscovered. Therefore, the last will and testament service method of the embodiment, in the coming aging society and in the society in which crimes producing random victims increase, can be used as preparations for unexpected death of not only the people being aware of their death such as the aged but also youths or people of mature age and it is expected that the users of the last will and testament service who wish to live positively by being prepared for death increase.

It is apparent that the present invention is not limited to the above embodiments but may be changed and modified without departing from the scope and spirit of the invention. For example, in the above Step S1 (will information and authentication information producing processing), contents that a present is to be given to the heir, in addition to the will information I1a, may be registered. Moreover, in the above Step S2 (will information registering processing), any arbitrary method to authenticate the testator may be employed if only the testator can be authenticated. Also, in the above Step S6 (will information transmitting processing), the will information I2 transmitted from the will service terminal 2 may be transferred not through the Internet but by post, by telegraph, by door-to-door parcel delivery services, or a like. Furthermore, if the will service terminal 2 is installed at an administrative body such as public offices, other local offices or a like, by connecting the public office terminal 3 to the will service terminal 2 through an intranet, the dead person information I3 may be transferred through the intranet.

What is claimed is:

1. A last will and testament service method in a last will and testament service system having a testator terminal, last will and testament service terminal, public office terminal, and communication line, comprising:
processing of producing will information and authentication information in which said testator terminal produces will information representing a will to an heir being left after the death of a testator and transmits it through said communication line to said last will and testament service terminal;
processing of registering said will information in which said last will and testament service terminal receives said will information and said authentication information through said communication line and, after having authenticated said testator based on said authentication information, registers and takes custody of said will information and charges a predetermined fee to said testator;
upon said death of said testator, processing of transmitting dead person information in which said public office terminal accepts a notice of death and records it as dead person information and transmits said dead person information through said communication line to said last will and testament service terminal; and
processing of transmitting said will information in which said last will and testament service terminal receives said dead person information through said communication line and compares said dead person information with said authentication information and, if said dead person information matches with said testator, transmits said will information to said heir of said testator in an arbitrary manner.

2. The last will and testament service method according to claim 1, wherein said communication line is the Internet.

3. A last will and testament service method in a last will and testament service system having a testator terminal, last will and testament service terminal, public office terminal, and communication line, comprising:
processing of producing will information and authentication information in which said testator terminal produces will information representing a will to an heir being left after the death of a testator and transmits it through said communication line to said last will and testament service terminal;
processing of registering said will information in which said will service terminal receives said will information and said authentication information through said communication line and, after having authenticated said testator based on said authentication information, registers and takes custody of said will information and charges a predetermined fee to said testator;
processing of transmitting updating information and authentication information in which said testator terminal transmits said updating information used to read, change, or add contents of said will information registered on said last will and testament service terminal, together with said authentication information, through said communication line, to said last will and testament service terminal;
processing of updating said will information in which said last will and testament service terminal receives said will information and authentication information through said communication line and, after having authenticated said testator based on said authentication information and, transmits, based on said updating information, said will information registered on said last will and testament service terminal, through said communication line, to said last will and testament terminal and changes or adds contents of said will information and charges a predetermined fee to said testator;
upon said death of said testator, processing of transmitting dead person information in which said public office terminal accepts a notice of death and records it as dead person information and transmits said dead person information through said communication line to said last will and testament service terminal; and
processing of transmitting said will information in which said last will and testament service terminal receives said dead person information through said communication line and compares said dead person information with said authentication information and, if said dead person information matches with said testator, transmits said will information to said heir of said testator in an arbitrary manner.

4. The last will and testament service method according to claim 3, wherein said communication line is the Internet.

5. A last will and testament service method in a last will and testament service system having a testator terminal, testator service terminal, public office terminal, and communication line, comprising:
processing of producing will information and authentication information in which said testator terminal produces said will information representing a will to an heir being left after the death of a testator and transmits it through said communication line to said last will and testament service terminal;
processing of registering said will information in which said last will and testament service terminal receives said will information and said authentication information through said communication line and, after having authenticated said testator based on said authentication information, registers and takes custody of said will information and charges a predetermined fee to said testator;
upon said death of said testator, processing of transmitting dead person information in which said public office terminal accepts a notice of death and records it as dead person information and transmits said dead person information through said communication line to said last will and testament service terminal;
processing of transmitting said will information in which said testator service terminal receives said dead person information through said communication line and compares said dead person information with said authentication information and, if said dead person information matches with said testator, transmits said will information through said communication line to said testator terminal; and
processing of receiving said will information in which said testator terminal receives said will information transmitted from said last will and testament service terminal through said communication line.

6. The last will and testament service method according to claim 5, wherein said communication line is the Internet.

7. A last will and testament service method in a last will and testament service system having a testator terminal, last will and testament service terminal, public office terminal, and communication line, comprising:
processing of producing will information and authentication information in which said testator terminal produces will information representing a will to an heir being left after the death of a testor and transmits it through said communication line to said last will and testament service terminal;
processing of registering said will information in which said last will and testament service terminal receives said will information and said authentication information through said communication line and, after having authenticated said testator based on said authentication information, registers and takes custody of said will information and charges a predetermined fee to said testator;
processing of transmitting updating information and said authentication information in which said testator terminal transmits said updating information used to read, change, or add contents of said will information registered on said last will and testament service terminal, together with said authentication information, through said communication line, to said last will and testament service terminal;
processing of updating said will information in which said last will and testament service terminal receives said will information and authentication information through said communication line and, after having authenticated said testator based on said authentication information, transmits, based on said updating service terminal, said will information registered on said last will and testament service terminal, through said communication line, to said last will and testament terminal and changes or adds contents of said will information and charges a predetermined fee to said testator;
upon said death of said testator, processing of transmitting dead person information in which said public office terminal accepts a notice of death and records it as dead person information and transmits said dead person information through said communication line to said last will and testament service terminal;
processing of transmitting said will information in which said last will and testament service terminal receives said dead person information through said communication line and compares said dead person information with said authentication information and, if said dead person information matches with said testator, transmits said will information through said communication line to said testator terminal; and
processing of receiving said will information in which said testator terminal receives said will information transmitted from said last will and testament service terminal through said communication line.

8. The last will and testament service method according to claim 7, wherein said communication line is the Internet.

9. A last will and testament service system comprising:
a testator terminal;
a last will and testament service terminal;
a public office terminal;
a communication line; and
wherein said testator terminal, based on manipulation of a testator, is so configured as to produce will information representing a will to an heir being left after the death of said testator and authentication information used to authenticate said testator and to transmit it through said communication line to said last will and testament service terminal,
wherein said last will and testament service terminal, based on manipulation of an operator in charge of a last will and testament service, is so configured as to receive said will information and said authentication information through said communication line and, after having authenticated said testator based on said authentication information, to register and take custody of said will information and to charge a predetermined fee to said testator; and upon said death of said testator to receive dead person information through said communication line and to compare said dead person information with said authentication information and, if said dead person information matches with said testator, to transmit said will information to said heir of said testator in an arbitrary manner; and
wherein said public office terminal, based on manipulation of an operator in charge of receiving a notice of death, is so configured as to receive said notice of death and to record it as dead person information and to transmit said dead person information through said communication line to said last will and testament service terminal.

10. The last will and testament service system according to claim 9 wherein said communication line is the Internet.

11. A last will and testament service system comprising:
a testator terminal;
a last will and testament service terminal;
a public office terminal;
a communication line; and
wherein said testator terminal, based on manipulation of a testator, is so configured as to produce will information representing a will to an heir being left after the death of said testator and authentication information used to authenticate said testator and to transmit it through said communication line to said last will and testament service terminal and, at the same time, to transmit updating information used to read, change, and add contents of said will information, together with said authentication information, through said communication line, to said last will and testament service terminal,
wherein said last will and testament service terminal, based on manipulation of an operator in charge of a last will and testament service, is so configured as to receive said will information and said authentication information through said communication line and, after having authenticated said testator based on said authentication information, to register and take custody of said will information and to charge a predetermined fee to said testator; and upon said death of said testator, to receive dead person information through said communication line and to compare said dead person information with said authentication information and, if said dead person information matches with said testator, to transmit said will information to said heir of said testator in an arbitrary manner and, at the same time, to receive said updating information and said authentication information through said communication line and, after having authenticated said testator based on said authentication being registered through said communication line to said testator terminal and to change or add said will information and to charge a predetermined fee to said testator; and
wherein said public office terminal, based on manipulation of an operator in charge of receiving a notice of death, is so configured as to receive said notice of death and to record it as dead person information and to transmit said dead person information through said communication line to said last will and testament service terminal.

12. The last will and testament service system according to claim 11 wherein said communication line is the Internet.

13. A last will and testament service system comprising:
a testator terminal;
a last will and testament service terminal;
a public office terminal;
a communication line; and
wherein said testator terminal, based on manipulation of a testator, is so configured as to produce will information representing a will to an heir being left after the death of said testator and authentication information used to authenticate said testator and to transmit it through said communication line to said last will and testament service terminal,
wherein said last will and testament service terminal, based on manipulation of an operator in charge of a last will and testament service, is so configured as to receive said will information and said authentication information through said communication line and, after having authenticated said testator based on said authentication information, to register and take custody of said will information and to charge a predetermined fee to said testator; and upon said death of said testator, to receive dead person information through said communication line and to compare said dead person information with said authentication information and, if said dead person information matches with said testator, to transmit said will information to said heir of said testator,
wherein said public office terminal, based on manipulation of an operator in charge of receiving a notice of death, is so configured as to receive said notice of death and to record it as dead person information and to transmit said dead person information through said communication line to said last will and testament service terminal; and
wherein said testator terminal, based on manipulation of said heir, is so configured as to receive said will information transmitted from said last will and testament service terminal through said communication line.

14. The last will and testament service system according to claim 13 wherein said communication line is the Internet.

15. A last will and testament service system comprising:
a testator terminal;
a last will and testament service terminal;
a public office terminal;
a communication line; and
wherein said testator terminal, based on manipulation of a testator, is so configured as to produce will information representing a will to an heir being left after the death of said testator and authentication information used to authenticate said testator and to transmit it through said communication line to said last will and testament service terminal and, at the same time, to transmit updating information used to read, change, and add contents of said will information, together with said authentication information, through said communication line, to said last will and testament service terminal,
wherein said last will and testament service terminal, based on manipulation of an operator in charge of a last will and testament service, is so configured as to receive said will information and said authentication information through said communication line and, after having authenticated said testator based on said authentication information, to register and take custody of said will information and to charge a predetermined fee to said testator; and upon said death of said testator, to receive dead person information through said communication line and to compare said dead person information with said authentication information and, if said dead person information matches with said testator, to transmit said will information through said communication line to said testator terminal and, at the same time, to receive said updating information and said authentication information through said communication line and, after having authenticated said testator based on said authentication information, to transmit, based on said updating information, said will information being registered through said communication line to said testator terminal and to change or add said will information and to charge a predetermined fee to said testator; and
wherein said public office terminal, based on manipulation of an operator in charge of receiving a notice of death, is so configured as to receive said notice of death and to record it as dead person information and to transmit said dead person information through said communication line to said last will and testament service terminal; and
wherein said testator terminal, based on manipulation of said heir, is so configured as to receive said will information transmitted from said last will and testament service terminal through said communication line.

16. The last will and testament service system according to claim 15 wherein said communication line is the Internet.

17. A storage medium storing control programs to have a computer implement a last will and testament service method in a last will and testament service system having a testator terminal, last will and testament service terminal, public office terminal, and communication line, said method comprising:
processing of producing will information and authentication information in which said testator terminal produces will information representing a will to an heir being left after the death of a testator and transmits it through said communication line to said last will and testament service terminal;
processing of registering said will information in which said last will and testament service terminal receives said will information and said authentication information through said communication line and, after having authenticated said testator based on said authentication information, registers and takes custody of said will information and charges a predetermined fee to said testator;
upon said death of said testator, processing of transmitting dead person information in which said public office terminal accepts a notice of death and records it as dead person information and transmits said dead person information through said communication line to said last will and testament service terminal; and
processing of transmitting said will information in which said last will and testament service terminal receives said dead person information through said communication line and compares said dead person information with said authentication information and, if said dead person information matches with said testator, transmits said will information to said heir of said testator in an arbitrary manner.

18. A storage medium storing control programs to have a computer to implement a functions of a last will and testament service system comprising:
a testator terminal;
a last will and testament service terminal;
a public office terminal;
a communication line; and
wherein said testator terminal, based on manipulation of a testator, is so configured as to produce will information representing a will to an heir being left after the death of said testator and authentication information used to authenticate said testator and to transmit it through said communication line to said last will and testament service terminal,
wherein said last will and testament service terminal, based on manipulation of an operator in charge of a last will and testament service, is so configured as to receive said will information and said authentication information through said communication line and, after having authenticated said testator based on said authentication information, to register and take custody of said will information and to charge a predetermined fee to said testator; and upon said death of said testator to receive dead person information through said communication line and to compare said dead person information with said authentication information and, if said dead person information matches with said testator, to transmit said will information to said heir of said testator in an arbitrary manner; and
wherein said public office terminal, based on manipulation of an operator in charge of receiving a notice of death, is so configured as to receive said notice of death and to record it as dead person information and to transmit said dead person information through said communication line to said last will and testament service terminal.
